(19) United States
(12) Patent Application Publication
(10) Pub. No.: US 2020/0189366 A1
(43) Pub. Date: Jun. 18, 2020

(54) DOOR GLASS ASSEMBLY FOR VEHICLE

(71) Applicants: Hyundai Motor Company, Seoul (KR); KIA Motors Corporation, Seoul (KR)

(72) Inventors: Hyung-Sik Choi, Seoul (KR); Gyung-Jae Heo, Hwaseong-si (KR); Jea-Hong Kim, Seoul (KR); Do-Hyun Shin, Seongnam-si (KR)

(73) Assignees: Hyundai Motor Company, Seoul (KR); Kia Motors Corporation, Seoul (KR)

(21) Appl. No.: 16/682,188

(22) Filed: Nov. 13, 2019

(30) Foreign Application Priority Data
Dec. 14, 2018 (KR) 10-2018-0162045

(51) Int. Cl. B60J 5/06; E05F 15/697

(52) U.S. Cl. CPC B60J 5/06; B60J 5/0402; E05F 15/697

(57) ABSTRACT

A door glass assembly for a vehicle is configured such that a driving motor for raising and lowering a door glass of the vehicle is directly connected to the door glass. The door glass assembly for the vehicle includes the door glass installed to be capable of being raised and lowered in a door of the vehicle and the driving motor for raising or lowering the door glass. The door glass assembly further includes a motion converting means for converting the rotational motion of the driving motor into the linear motion of the door glass between the driving motor and the door glass.

### CROSS-REFERENCE TO RELATED APPLICATIONS

This application claims priority to and the benefit of Korean Patent Application No. 10-2018-0162045, filed on Dec. 14, 2018, which is incorporated herein by reference in its entirety.

### FIELD

The present disclosure relates to a door glass assembly for a vehicle having a door.

### BACKGROUND

The statements in this section merely provide background information related to the present disclosure and may not constitute prior art.

Doors of a vehicle are provided with door glasses for lighting and/or ventilation. The door glass installed in a side door is capable of being raised or lowered. In addition, most types of vehicles are provided with a so-called ‘power window’ for automatically raising or lowering the door glass.

FIG. 1 shows a door 100 of a vehicle.

The door glass 120 installed inside a door frame 110 is capable of being raised or lowered. The door glass 120 can be raised or lowered by means of a regulator 140 when a switch is actuated by an occupant. The regulator 140 installed inside the door 100 includes a driving motor 141, a drum 142 driven by the driving motor 141, a wire 143 moved by the drum 142 and pulleys 144 for guiding movement of the wire 143. The wire 143 converts the rotational motion of the drum 142 to reciprocating motion in a raising or lowering direction to raise or lower a glass holder 121 to which the door glass 120 is mounted, thereby raising or lowering the door glass 120.

However, in the case where the door glass 120 is raised or lowered by means of the regulator 140 as described above, a moment of force is generated in a front and rear direction of a vehicle. In FIG. 2, the moment causes abnormal contact between the door glass 120 and a glass run 131 which surrounds and supports the door glass 120, and the abnormal contact causes the glass run 131 to be worn down or causes noise to be generated at the contact portion. In other words, in the case where the glass run 131 made of a rubber material is inserted into the door frame 110 and the glass run 131 surrounds and supports the door glass 120 as shown in FIG. 2, if the moment is generated when the door glass 120 is raised or lowered, the door glass 120 moves back and forth in the forward and backward direction from its normal position. Accordingly, it results in abnormal contact between the door glass 120 and the glass run 131. Reference numerals 132, 133 and 134 not described herein denote a garnish which is an exterior material, a trim which is an interior material and a weather strip which is an airtight sealing member, respectively.

The above information disclosed in this Background section is only for enhancement of understanding of the background of the present disclosure, and therefore it may contain information that does not form the prior art that is already known to a person of ordinary skill in the art.

### SUMMARY

The present disclosure relates to a door glass assembly for a vehicle. In the door glass assembly, a motor and a door glass are directly coupled to each other so that rotational force of the motor is directly converted into linear motion to raise or lower the door glass.

In accordance with one aspect of the present disclosure, a door glass assembly for a vehicle includes a door glass installed to be capable of being raised and lowered in a door of the vehicle and a driving motor for raising or lowering the door glass. The door glass assembly further includes a motion converting means for converting rotational motion of the driving motor into linear motion of the door glass between the driving motor and the door glass.

In accordance with a further aspect of the present disclosure, the motion converting means includes a driving gear fastened to a rotating shaft of the driving motor, and a rail fastened to either a front end or a rear end of the door glass and formed with a rack gear portion meshed with the driving gear along an ascending or descending direction of the door glass.

The driving motor is located at an end of the door adjacent to a center pillar of the vehicle.

The rack gear portion is formed to extend downward by a predetermined length from a lower end of the door glass.

The rack gear portion is formed on a side of the rail facing a center pillar of the vehicle.

A roller for supporting the rail in contact with the rail is provided at a side of the rail opposite to the side on which the rack gear portion is formed.

An imaginary line connecting a rotation axis of the roller and a rotation axis of the driving gear is perpendicular to a longitudinal direction of the rail.

In accordance with a further aspect of the present disclosure, a slider for guiding ascending or descending of the door glass is fastened to at least one of front and rear ends of the door glass.

The slider is a first slider fastened to an end of the door glass adjacent to a center pillar of the vehicle and inserted into a glass run installed in the door.

The slider is a second slider fastened to an end of the door glass adjacent to any one of front and rear pillars of the vehicle and inserted into a glass run installed in the door.

The slider is located within a sliding groove formed inside a door frame.

A support for supporting the slider is attached to the door glass and the slider is mounted to an end of the support.

In the door glass assembly according to the present disclosure having the features as described above, since the motor is coupled directly to the door glass such that rotational motion of the motor is directly converted into linear motion to raise and lower the door glass, moment forcing the door glass to move in a forward and backward direction does not occur when the door glass is raised or lowered.

In addition, since the moment forcing the door glass to move in the forward and backward direction does not occur when the door glass is raised or lowered, abnormal contact between the door glass and the glass run does not occur.

Further, since the abnormal contact between the door glass and the glass run does not occur, it is possible to inhibit abrasion of the glass run and occurrence of noise at the contact portion.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view of a door glass assembly according to prior art;

FIG. 2 is a sectional view taken along line I-I of FIG. 1;

FIG. 3 is a view showing a state in which a door glass is raised in a door glass assembly for a vehicle according to a form of the present disclosure;

FIG. 4 is a view showing a state in which a door glass, sliders and a rail of a front door are assembled in a door glass assembly for a vehicle according to a form of the present disclosure;

FIG. 5 is a cross sectional view of the door glass assembly taken along line II-II of FIG. 3;

FIG. 6 is an enlarged view of a portion A in the door glass assembly of FIG. 3;

FIG. 7 is a cross sectional view of the door glass assembly taken along line III-III of FIG. 3;

FIG. 8 is a view showing a state in which a door glass is lowered in a door glass assembly for a vehicle according to a form of the present disclosure; and

FIG. 9 is a view showing a state in which a door glass, sliders and a rail of a rear door are assembled in a door glass assembly for a vehicle according to a form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, a door glass assembly for a vehicle according to a form of the present disclosure will be described in detail with reference to the accompanying drawings.

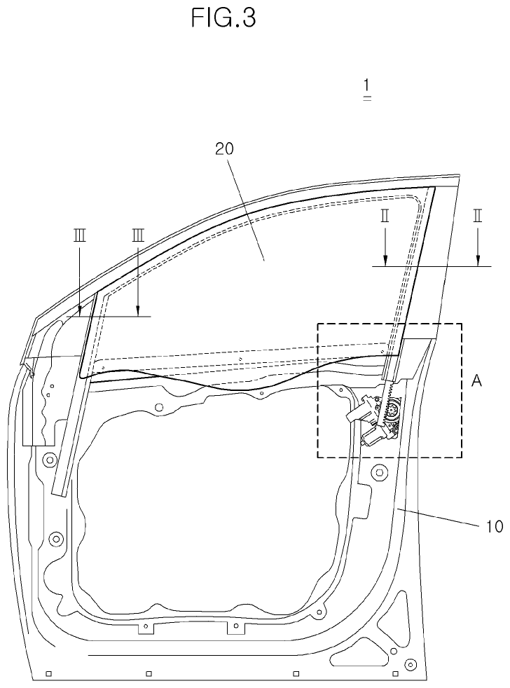

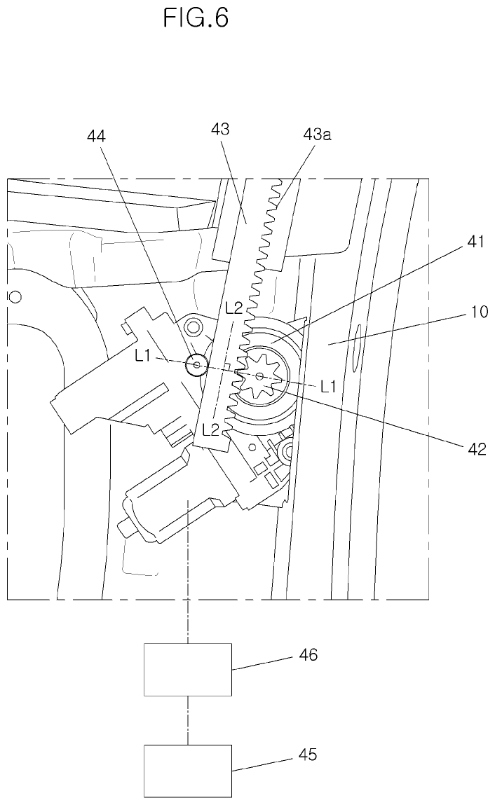

Referring to FIGS. 3 and 6, a door glass assembly for a vehicle according to a form of the present disclosure comprises a door glass 20 installed to be capable of being raised and lowered in a door 1 of a vehicle and a driving motor 41 for raising or lowering the door glass 20. A motion converting means for converting rotational motion of the driving motor 41 into linear motion of the door glass 20 is provided between the driving motor 41 and the door glass 20, and the motion converting means comprises a driving gear 42 fastened to a rotating shaft of the driving motor 41 and a rail 43 fastened to either a front end or a rear end of the door glass 20 and formed with a rack gear portion 43a meshed with the driving gear 42 along an ascending or descending direction of the door glass 20.

The door glass 20 is installed in the door 1 for being raised or lowered.

The door glass 20 is raised or lowered by means of the driving motor 41 installed inside the door 1. As described above, the motion converting means for converting rotational motion of the driving motor 41 into ascending or descending motion of the door glass 20 is provided between the door glass 20 and the driving motor 41.

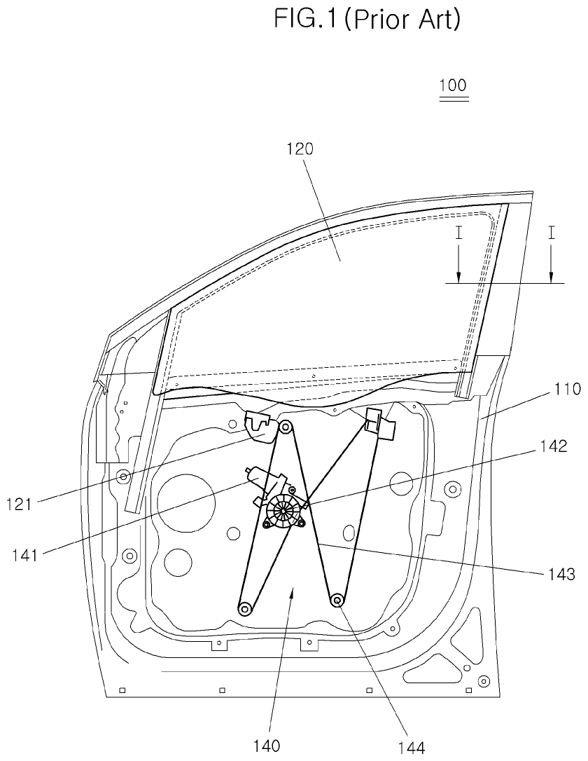

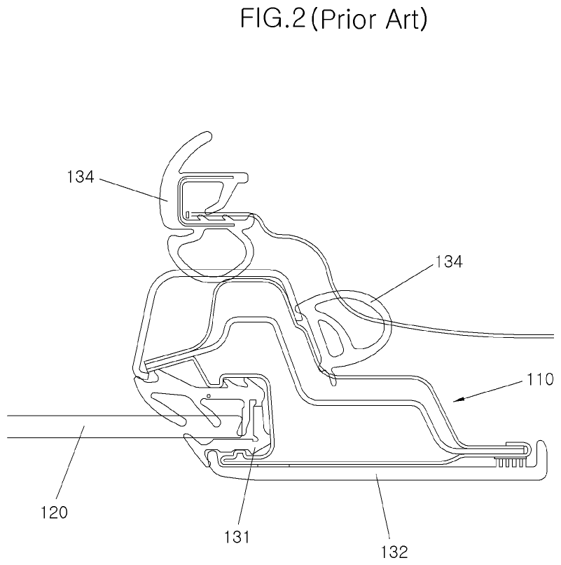

In the prior art of FIGS. 1 and 2, such a motion converting means is a regulator including a wire. However, according to a form of the present disclosure, the motion converting means is constituted by a driving gear 42 and a rail 43.

The driving gear 42 is fastened to a rotating shaft of the driving motor 41. The driving motor 41 is driven and rotates the driving gear 42 when an occupant operates a switch 45 in order to raise or lower the door glass 20.

The rail 43 is installed at an end of the door glass 20 along the ascending or descending direction of the door glass 20. The rail 43 may be installed at an end of the door glass 20 adjacent to a center pillar of the vehicle. For example, in the case of the door glass 20 to be installed in a front door, the rail 43 is installed at a rear end of the door glass 20 as shown in FIG. 3. On the contrary, in the case of the door glass 20 to be installed in a rear door, the rail 43 is preferably installed at a front end of the door glass 20. This is because a length of the end of the door glass 20 adjacent to the center pillar is longer than the opposite end.

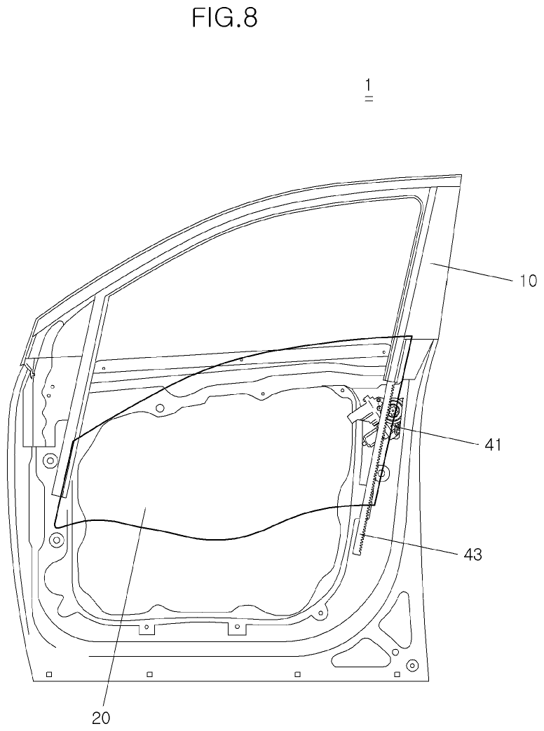

As shown in FIGS. 3 and 8, the rail 43 is formed with a rack gear portion 43a which is meshed with the driving gear 42. The rack gear portion 43a is formed to extend downward by a predetermined length from a lower end of the door glass 20.

The rack gear portion 43a is meshed with the driving gear 42 whereby rotational motion of the driving gear 42 can be converted into a linear motion such as ascending or descending motion of the rail 43. Particularly, the rack gear portion 43a is formed on a side of the rail 43 facing the center pillar of the vehicle. In other words, in the case where the rail 43 is mounted to the door glass 20 installed in the front door, the rack gear portion 43a is formed on the side of the rail facing the rear of the vehicle. Further, the driving motor 41 is also located at a portion of the door adjacent to the center pillar of the vehicle.

In FIG. 6, a roller 44 supports a side of the rail 43, on which the rack gear portion 43a is not provided. In the case where the rack gear portion 43a is formed on the side of the rail 43 facing the center pillar, the roller 44 is arranged to abut against the opposite side of the rail, that is, the side facing the front of the vehicle. The roller 44 supports the side opposite to the portion where the rack gear portion 43a is meshed with the driving gear 42, thereby securing the engagement between the driving gear 42 and the rack gear portion 43a. In particular, the roller 44 is preferably installed such that an imaginary line L1-L1 connecting a rotation axis of the roller 44 and a rotation axis of the driving gear 42 is perpendicular to a longitudinal direction L2-L2 of the rail 43 (see FIG. 6).

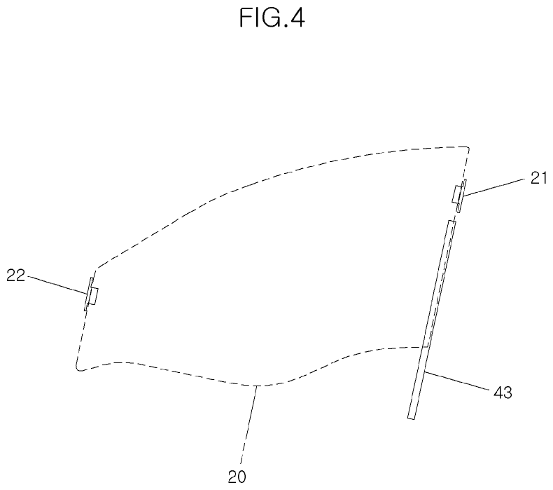

Referring to FIGS. 4, 5, and 7, sliders 21 and 22 for guiding ascending or descending of the door glass 20 when the door glass 20 is raised or lowered are fastened to the door glass 20.

The slider may be a first slider 21 fastened to a portion above the rail 43 at the end of the door glass 20 adjacent to the center pillar of the vehicle and inserted into the glass run 31 installed in the door 1, or a second slider 22 fastened to the end of the door glass 20 adjacent to a pillar opposite to the center pillar, that is, a front pillar or a rear pillar, and inserted into the glass run 31 installed in the door 1. For example, in the case of the door glass 20 of the front door, the first slider 21 is installed at an upper portion of the rear end of the door glass 20 adjacent to the center pillar while the second slider 22 is installed at the front end of the door glass 20 adjacent to the front pillar.

The sliders 21 and 22 are located within sliding grooves formed inside the door frame 10 respectively. The sliders 21 and 22 are configured as for example rollers and supported by supporters 21a and 22a adhesively attached to the door glass 20. Since the sliders 21 and 22 are located within the sliding grooves so that they are brought into contact with inner side walls of the sliding grooves in the sliding grooves and rotated when the door glass 20 is raised or lowered, they can guide ascending or descending of the door glass 20 while reducing friction that may occur when the door glass 20 is raised or lowered. In particular, the first slider 21 is raised or lowered in a state in which it is restrained in both the front and rear direction and the left and right direction of the vehicle in the sliding groove, while the second slider 22 is raised or lowered in a state that it is restrained in the sliding groove in the left and right direction of the vehicle.

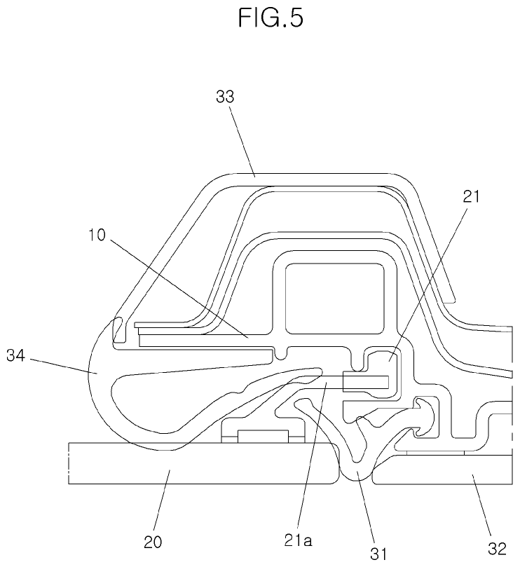

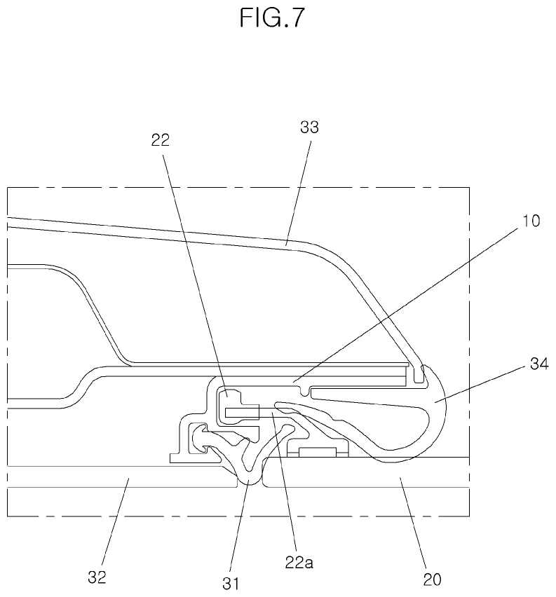

As shown in FIGS. 5 and 7, the front and rear ends of the door glass 20 are supported by the glass runs 31 respectively. A garnish 32 as an exterior material is attached to the outside of the door frame 10, and a trim 33 as an interior material is attached to the inside of the door frame 10. Further, a weather strip 34 for airtight sealing is mounted at a portion where the door 1 is abutted against the vehicle body.

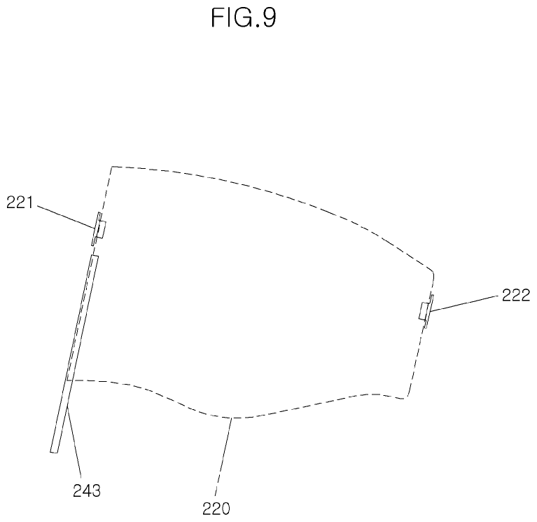

According to another form of the present disclosure, in the case where the door glass 220 is installed in the rear door, the first slider 221 is installed at a portion above the rail 243 at the front end of the door glass 220 while the second slider 222 is installed at the rear end of the door glass 20′ as shown in FIG. 9.

Next, an operation of the door glass assembly for a vehicle according to a form of the present disclosure having the configuration as described above will be described below.

As shown in FIG. 6, when intending to raise or lower the door glass 20 in the interior of the vehicle, an occupant operates the switch 45 installed inside the vehicle. When the switch 45 is actuated, a control unit 46 applies electric power to the driving motor 41 to raise or lower the door glass 20.

The control unit 46 may also apply electric power to the driving motor 41 even when it is determined that the door glass 20 should be raised in response to the surrounding situation during running of the vehicle. For example, in recent years, there is a vehicle to which a technique for actuating the door glass 20 to be raised or lowered when a current location of the vehicle acquired from a navigation system is expected to approach a tunnel is applied. As such, the control unit 46 may be configured to apply electric power to the driving motor 41 when it is determined that the door glass 20 should be raised.

When the electric power is applied to the driving motor 41, the driving motor 41 is rotated and the driving gear 42 is rotated accordingly.

When the driving gear 42 is rotated, the rail 43 engaged with the driving gear 42 is raised or lowered whereby the door glass 20 to which the rail 43 is coupled is raised or lowered accordingly.

At this time, the rail 43 can be raised or lowered stably because the rear side of the rail 43 is supported by the roller 44.

Since the rail 43 formed with the rack gear portion 43a is fastened to the portion of the door glass 20 adjacent to the center pillar and the door glass 20 is raised and lowered by raising or lowering the rail 43 by means of the driving motor 41, the moment that causes abnormal contact between the door glass 20 and the glass run 31 does not occur.

Further, since the first slider 21 and the second slider 22 are installed at portions spaced apart from the portion where the rail 43 is installed, for example, the front end of the door glass 20 and the upper end of the door glass 20 respectively and both the first slider 21 and the second slider 22 are guided by the door frame 10, endurance performance of the door glass 20 can be improved.

While this present disclosure has been described in connection with what is presently considered to be practical exemplary forms, it is to be understood that the present disclosure is not limited to the disclosed forms, but, on the contrary, it is intended to cover various modifications and equivalent arrangements included within the spirit and scope of the present disclosure.

What is claimed is:

1. A door glass assembly for a vehicle, the door glass assembly comprising:
a door glass installed in a manner to be raised and lowered in a door of the vehicle;
a driving motor for raising or lowering the door glass; and
a motion converting means for converting rotational motion of the driving motor into linear motion of the door glass, the motion converting means being provided between the driving motor and the door glass.

2. The door glass assembly according to claim 1, wherein the motion converting means comprises a driving gear fastened to a rotating shaft of the driving motor and a rail fastened to either a front end or a rear end of the door glass and formed with a rack gear portion meshed with the driving gear along an ascending or descending direction of the door glass.

3. The door glass assembly according to claim 2, wherein the driving motor is located at an end of the door adjacent to a center pillar of the vehicle.

4. The door glass assembly according to claim 2, wherein the rack gear portion is formed to extend downward by a predetermined length from a lower end of the door glass.

5. The door glass assembly according to claim 2, wherein the rack gear portion is formed on a side of the rail facing a center pillar of the vehicle.

6. The door glass assembly according to claim 2, wherein a roller for supporting the rail in contact with the rail is provided at a side of the rail opposite to the side on which the rack gear portion is formed.

7. The door glass assembly according to claim 6, wherein an imaginary line connecting a rotation axis of the roller and a rotation axis of the driving gear is perpendicular to a longitudinal direction of the rail.

8. The door glass assembly according to claim 1, wherein a slider for guiding ascending or descending of the door glass is fastened to at least one of front and rear ends of the door glass.

9. The door glass assembly according to claim 8, wherein the slider is a first slider fastened to an end of the door glass adjacent to a center pillar of the vehicle and inserted into a glass run installed in the door.

10. The door glass assembly according to claim 8, wherein the slider is a second slider fastened to an end of the door glass adjacent to any one of front and rear pillars of the vehicle and inserted into a glass run installed in the door.

11. The door glass assembly according to claim 8, wherein the slider is located within a sliding groove formed inside a door frame.

12. The door glass assembly according to claim 8, wherein a support for supporting the slider is attached to the door glass and the slider is mounted to an end of the support.

13. A door glass assembly for a vehicle, the door glass assembly comprising:
a door glass installed in a manner to be raised and lowered in a door of the vehicle;
a driving motor for raising or lowering the door glass, the driving motor having a rotating shaft;
a driving gear fastened to the rotating shaft of the driving motor; and
a rail fastened to at least one of a front end and a rear end of the door glass, the rail formed with a rack gear portion meshed with the driving gear along an ascending or descending direction of the door glass.
